(19) United States
(12) Patent Application Publication
(10) Pub. No.: US 2008/0110413 A1
(43) Pub. Date: May 15, 2008

(54) Pet Barrier

(75) Inventors: Terutoki Kobayashi, Toyama City (JP); Shingi Otani, Toyama City (JP); Hideo Yoshida, Toyama City (JP)

Correspondence Address: CONLEY ROSE, P.C., 5601 GRANITE PARKWAY, SUITE 750, PLANO, TX, 75024, US

(73) Assignee: RICHELL USA, INC., Grand Prairie, TX (US)

(21) Appl. No.: 11/938,780

(22) Filed: Nov. 12, 2007

(30) Foreign Application Priority Data
Nov. 13, 2006 (JP) 2006-307203

(51) Int. Cl. A01K 1/035

(52) U.S. Cl. 119/514

(57) ABSTRACT

A pet gate is disclosed. The pet gate having a front panel with a side panel disposed at each side of the front panel. Each side panel of the pet gate extends in a direction of intersection with the front panel allowing the pet gate to stand alone. The pet gate further comprises a door formed by one of the side panels in its entirety. The door is coupled on one side to the front panel by a hinge that allows rotation. The other side of the door is not coupled to a structural element. This allows the door to swing about the hinge in such a way that when in a state of use, the door opens and closes to allow passage of persons. The gate is set to a height such that it is difficult for a person to step over the gate.

### CROSS-REFERENCE TO RELATED APPLICATIONS

This application claims priority to Patent Application Serial No. JP2006-307203, entitled “Pet Barrier”, filed with the Japan Patent Office on Nov. 13, 2006, under the Paris Convention for the Protection of Industrial Property.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE DISCLOSURE

This disclosure relates to a freestanding pet gate to prevent entry of pet into proscribed areas.

### BACKGROUND OF THE DISCLOSURE

When animals are kept as pets, sometimes the owners wish to prevent the animals from entering proscribed areas such as the kitchen or the entrance area.

Mounting a rail or gate between columns or walls is a known technique, but this technique could not be used in places where there are no columns or walls, and once mounted, the operation for removing the rail or gate is difficult.

Japanese Patent Application No. 2006-42792 discloses a freestanding gate (a gate which is independent of support from a wall, column, or other separate building fixture) that is set at a height that people can step over.

Setting the height of the gate such that people can step over it is excellent in that people can pass while pets are prevented from entering. However, when used for comparatively large pets or for pets capable of jumping high, there is a concern that the animals could jump over the gate.

In addition, even when the height of the gate is set low, stepping over the gate is difficult for the elderly and for children. Also, women wearing skirts may not be comfortable with stepping over the gate.

### SUMMARY OF THE DISCLOSURE

In an embodiment of the disclosure, a pet gate is disclosed. The pet gate has a front panel with a side panel disposed at each side of the front panel. Each side panel of the pet gate extends in a direction of intersection with the front panel allowing the pet gate to stand alone. The pet gate further also has a door formed by one of the side panels in its entirety. The door is coupled on one side to the front panel by a hinge that allows rotation. The other side of the door is not coupled to a structural element. This allows the door to swing about the hinge in such a way that when in a state of use, the door opens and closes to allow passage of persons. The gate is also set to a height such that it is difficult for a person to step over the gate.

In another embodiment of the disclosure, a pet gate is disclosed. In one example of this embodiment, the pet gate has a height in the range between 55 cm and 100 cm and, more specifically, between 65 cm and 80 cm. The gate has an extensible front panel comprised of multiple panels overlapping in a horizontal direction. The gate also has four holding members extending in a cross direction at right angles to the front panel and situated at both end lower portions of the front panel. The pet gate may also have support members positioned and integrally formed under the gate and support members that extend to a back surface side of the support members positioned under the gate. The support members that extend to the back surface side are integrally formed with the gate and the support members positioned under the gate. A door is positioned above at least one support member extending in a cross direction of the front panel. A lock device may also be mounted on the door, such that the door is released by operating the lock device. A hinge may be provided on the door at a side where the door folds with the lock device mounted at a side opposite the side where the door folds. The hinge is operable to open and close the door on a generally perpendicular axis. The door opens and closes around the perpendicular axis vicinity and has a width through which people can pass. Hence, in this embodiment, when the pet gate is placed to block entry to an area, entry and exit to the area is from a side of the front panel.

In yet another embodiment of the disclosure, a pet gate is disclosed which in one version may have a height in the range between 55 cm and 100 cm and, more specifically, between 65 cm and 80 cm. The gate has a front panel extensible at a portion where multiple panels overlap. The gate also has four leg members which extend in a cross direction at right angles with respect to a front panel surface at both end lower portions of the front panel. The gate further has a door of a width through which people can pass positioned above at least one support member extending in a cross direction of the front panel such that the door opens and closes in a perpendicular axis vicinity. A lock device is mounted on the door. The gate also has a hinge which opens and closes the door in the perpendicular axis vicinity, and locks the door at a right angle position to the front panel surface by operating the lock device. Accordingly, when the pet gate is placed to block entry to an area, entry and exit to the area is from a side of the front panel.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1 and 1(a) (collectively referred to as FIG. 1) show two views of the reverse C shape pet gate of the disclosure viewed from the outer side;

FIGS. 2, 2(a) and 2(b) (collectively referred to as FIG. 2) show three views of the reverse C shape pet gate of the disclosure viewed from the inner side;

FIGS. 3(a), 3(a)1, 3(b), 3(b)1 and 3(b)2 (collectively referred to as FIG. 3) show the front and planar views of the pet gate of the disclosure;

FIGS. 4 and 4(a) (collectively referred to as FIG. 4) show the structure of the side panel;

FIGS. 5(a)-(e) (collectively referred to as FIG. 5) show the structure of the lock device in different operational views;

FIG. 6 illustrates the joined portion in the state where the side panel is rotated to the front panel side when viewed from the outer side;

FIGS. 7, 7(a) and 7(b) (collectively referred to as FIG. 7) illustrate the state in which the side panel is separated from the front panel;

FIG. 8 illustrates an example in which a door is provided in the front panel;

FIG. 9 illustrates an example in which a door is provided in the side panel;

FIG. 10 and FIG. 11 illustrate an example in which a caster is mounted to the front panel;

FIG. 12 illustrates a separate example of the support member; and

FIGS. 13(a)-(b) illustrate examples in which the hinge has a lock function.

### DETAILED DESCRIPTION OF THE PREFERRED EMBODIMENTS

The disclosure provides a freestanding pet gate in which entry of comparatively large pets or pets capable of jumping high is effectively prevented and people can pass easily.

In some of the embodiments of the pet gate of the disclosure, entry of small animals, as well as comparatively large animals, is prevented by setting the height of the gate such that it is difficult for people to step over, but when people pass through, the side panels are rotated with respect to the front panel. A door capable of being opened and closed may also be provided in a side panel or a front panel, and thus, average adults, as well as children and lame people, can pass through.

Because the side panel extends in the direction of intersection with the front panel and is capable of standing alone, there is no need to be selective in mounting the gates as it can be mounted anywhere. In addition to allowing the gate to stand alone, the side panel functions to prevent the animal from slipping out from the side of the front panel.

When the side panel is rotated at the time a person passes through in the in-use state and if the lower surface of the side panel contacts the mounting surface, a large frictional force is sometimes generated. Accordingly, in one embodiment, when the side panels rotate with respect to the front panel, a slight rising from the mounting surface is possible. In rotating the side panel with respect to the front panel, the side panel is lifted up a little and slightly raised. In some embodiments, this is facilitated by a hinge designed to provide the slight lifting by its construction or to provide the limits of lifting by its construction. The hinge may also provide a locking mechanism depending on its relative lift position.

One embodiment of the disclosure provides a freestanding pet gate comprising a front panel and a side panel disposed at each side of the front panel. Each side panel of the pet gate extends in a direction of intersection with the front panel allowing the pet gate to stand alone, free of any structural element, such as a wall, column, or any other building fixture. The pet gate further comprises a door formed by one of the side panels in its entirety. The door is coupled on one side to the front panel by a hinge that allows rotation. As a part of being a component of a freestanding pet gate, the uncoupled side of the door is independent and free of any structural element, such as a wall, column, or any other building fixture (referred to later herein simply as being “free” or being allowed to “swing free”). This allows the door to swing about the hinge in such a way that when in a state of use, the door opens and closes to allow passage of persons. The gate is set to a height such that it is difficult for a person to step over the gate.

A gate height which is difficult for people to step over herein refers to a height which an adult finds difficult to step over. For purposes of this disclosure, any height exceeding about 55 cm is difficult to step over, and a height exceeding 65 cm is difficult for most people to step over. As a result, the height of the gate in one embodiment could be set in the range between 55 cm and 100 cm and, more preferably, in the range between 65 cm and 80 cm.

An example of the structure that can stand alone with the side panel extending in the direction of intersection with the front panel is one in which in the planar view, the front panel and the side panels form substantially a reverse C shape or an H shape. In the case of the reverse C shape, the front panel and the side panels are formed substantially in the reverse C shape, and the support member extends in the direction opposite to the side panels which form the side pieces of reverse C shape. This allows stand-alone stability to be high.

The in-use state of the pet gate in the disclosure (also referred to simply as “gate” hereinafter) refers to the state where it is placed to stand alone at a proscribed location such as a kitchen or entrance area to prevent entry of animals. The pet gate has a door which can open and close when people pass through in this in-use state. The pet gate door may be provided on the front panel or on a side panel. The side panels may be joined so as to be rotatable with respect to the front panel, and when the side panels rotate, people can pass through.

In a second embodiment, where the side panel is rotated as a door, the side panel prevents the animal from slipping through the sides of the front panel and also functions as an open and close door through which people can pass. The structure is also simpler than that in which an open and close door is provided in the front panel or in a side panel, and the number of parts used is reduced.

In addition, an open and close door may be provided in the front panel or in a side panel. In such cases, a lower frame or a lower beam for supporting the door under the panel is necessary. However, in cases where the side panels open and close, the lower frame becomes unnecessary, and therefore, any concern that a person may trip over the lower frame when stepping over the gate is thereby removed.

As noted above, in one embodiment, when the side panels rotate with respect to the front panel, a slight rising from the mounting surface is possible. In rotating the side panel with respect to the front panel, the side panel is lifted up a little and slightly raised. Thus, easing the opening and closing operation. The description that a slight rising is possible refers to when the side panel rotates, it is raised to an extent that no great frictional force is generated on the lower surface. The rise amount is preferably 2 mm to 4 mm. If the rise amount exceeds 4 mm, the space between the lower surface of the side panel and the mounting surface becomes large, and the possibility that a hand or foot of an animal or infant could be caught therein arises.

In a fourth embodiment, the front panel is formed such that it can contract in the width direction. One example of an extensible structure is a structure in which the front panel is formed of multiple panels, and these multiple panels are placed so as to overlap in the cross direction. The total width is adjusted by adjusting this cross direction overlap amount, or another panel may fit by sliding into the side of one panel.

In a fifth embodiment, the front panel and the side panels may also be joined so that they can be assembled and disassembled. When the front panel and the side panels can be disassembled, storage is easy, and the device is more compact.

In a sixth embodiment, the front panel and/or the side panels comprise a frame portion and linear members which are placed inside the frame portion, and the middle ⅖ of the front panel and/or the side panels, starting at the vertical center and extending at least ⅕ of the vertical height of the panel in each direction, has only vertical direction linear members. Stated in another way, there may be horizontal members in addition to the horizontal frame members of the front panel and/or the side panels. However, these horizontal members are preferably only present in at most the vertical extreme 3/10 of the front panel and/or the side panels. In other words, these horizontal members are preferably only present in at most the portion of the panel starting at the top or the bottom and extending no more than 3/10 of the vertical height towards the center. This portion of the panel is also referred to as the top 3/10 and the bottom 3/10.

The front panel and the side panel may be formed to have a plate-like shape, but if the panel is formed of a frame and linear members which are placed in this frame, the field of vision for the animal or owner will be good. In the case where the panel is formed of a frame and linear members and the middle ⅖ or more preferably has only vertical direction linear members, there is nowhere for the animal to put its feet. Thus, the danger that the animal will put its feet on the linear members and jump over the gate is removed.

In a seventh embodiment, the pet gate comprises an extensible front panel at the portion where multiple panels overlap and four holding members which extend in the cross direction at right angles to the front panel surface at both end lower portions of the front panel. A door of a width through which people can pass is provided above at least one support member which extends in the cross direction of the front panel such that the door can open and close in the perpendicular axis vicinity. The door is released by operating a lock device such that when the door is positioned to block the opening of a room or passageway, exit from the side of the front panel possible.

In an eighth embodiment, the gate and the support members may be positioned under the gate or integrally formed.

In a ninth embodiment, the gate and the support members positioned under the gate and support members which extend to the back surface side of the support members positioned under the gate may also be integrally formed.

In a tenth embodiment, the door is provided so as to be attachable and detachable using removable hinges.

In an eleventh embodiment, the hinge that is provided such that the door can open and close in the perpendicular axis vicinity is provided at the side where the door folds, and the lock device is mounted at the side opposite to the side where the door folds.

In a twelfth embodiment, the pet gate may also comprise a front panel extensible at the portion where multiple panels overlap and four leg members which extend in a cross direction at right angles with respect to the front panel surface at both end lower portions of the front panel. A door of a width through which people can pass is positioned above at least one support member which extends in the cross direction of the front panel such that it can open and close in the perpendicular axis vicinity using a hinge. In this embodiment, the hinge also functions to lock the door at a position at right angles to the surface of the front panel. By operating a lock device when the door is placed so as to block the opening of a room or passageway, the door is released, and entry and exit from the side of the front panel is possible.

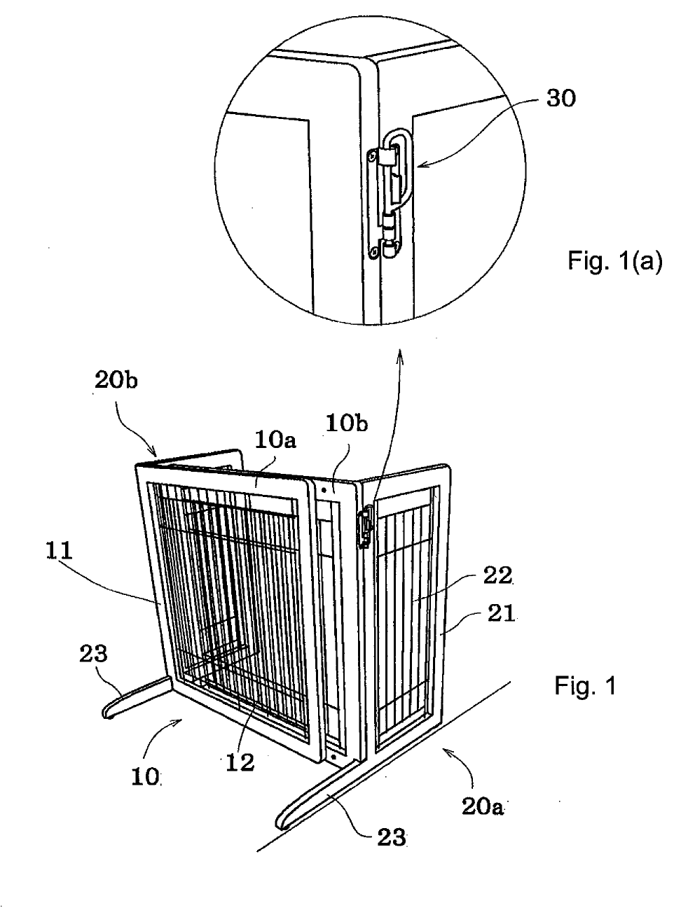

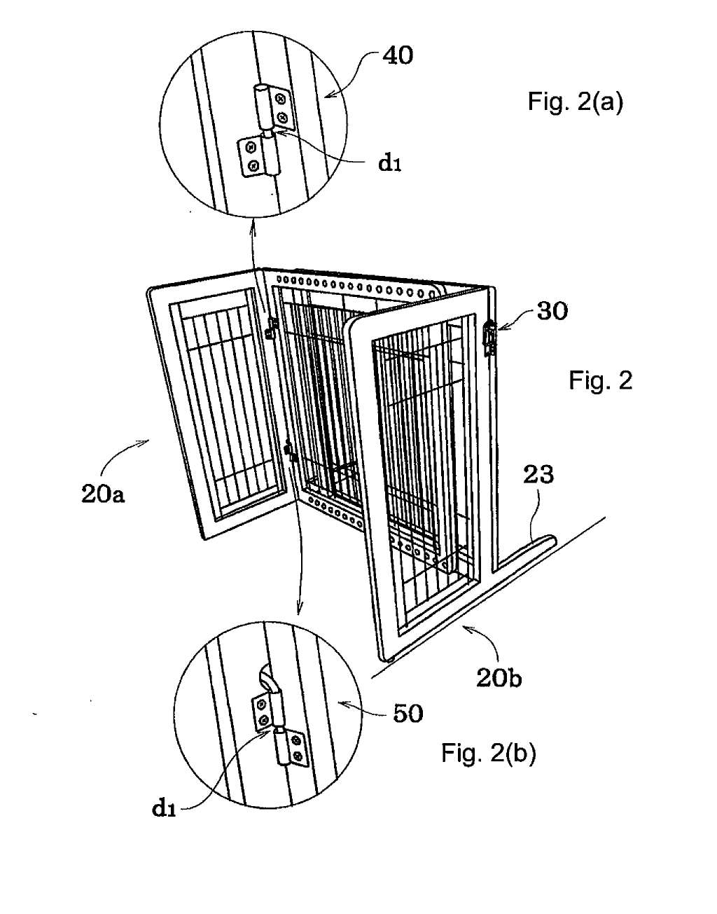

An outer perspective view of the pet gate of this embodiment is shown in FIG. 1 and FIG. 2.

The example of the pet gate shown in this working example substantially has a reverse C shape in a planar view. FIG. 1 is a perspective view of the reverse C shape viewed from the outer side, while FIG. 2 is a perspective view from the inner side. The side panels 20a and 20b are joined to both sides of the front panel 10 so as to be rotatable with respect to the front panel.

The gate of the disclosure can be placed at any location. Thus, although there is no distinction between the front and back of the front panel, for convenience in explanation, the outer side of the reverse C shape in the planar view is called the face or the forward direction, and the inner side is called the back or the rear direction.

In the working example of FIG. 1, the front panel 10 is formed of two panels 10a and 10b.

The basic structure of the panels 10a and 10b is mostly the same, but the panel 10a will be described in the following, and similar parts on panel 10b have been assigned the same numbers.

The panel 10a controls the passage of a pet and comprises a rectangular frame 11 that is set at height that is difficult for people to step over and linear members 12 which are disposed inside the frame.

The height of the gate is set in the range between 55 cm and 100 cm, and more preferably set in the range between 65 cm and 80 cm.

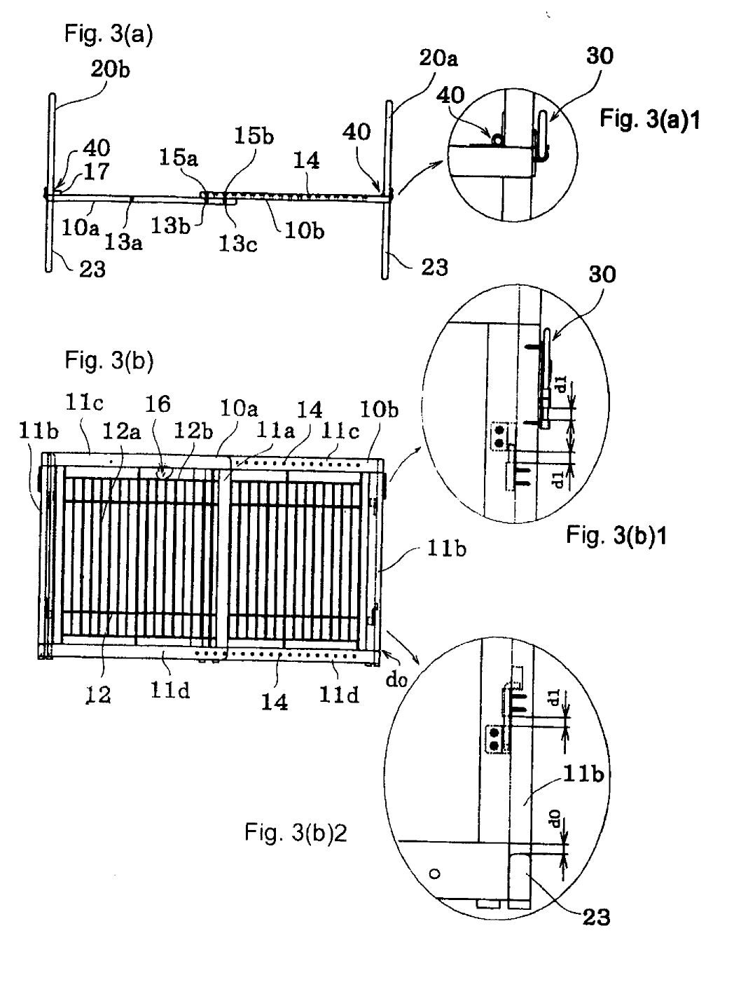

As shown in the front view of FIG. 3b in which the total width of the front panel is increased to be more than that of FIG. 1, the frame 11 comprises left and right vertical members 11b and 11a and upper and lower horizontal members 11c and 11d, and the linear member 12 mainly comprises vertical direction members 12a, and two horizontal linear members are provided at each of the upper and lower portion.

The middle ⅖ or more of the front panel is formed with only the vertical direction member 12a in order to prevent placement of animal feet. That is to say that there may be horizontal members in addition to the horizontal frame members of the front panel. However, these horizontal members are preferably only present in at most the vertical extreme 3/10 of the front panel.

In addition, the vertical direction members 12a were provided with a handle space 16 by drawing out the upper side of the frame 11, and thus it is easy for the gate to be held with the hands when it is being moved.

One portion of the two panels 10a and 10b overlap in the cross direction, and FIG. 3 shows a state in which the width is wider than in FIG. 1.

The total width of the two panels 10a and 10b that have been disposed in the cross direction can be adjusted by increasing or decreasing the cross direction overlap portion.

Three insertion nuts 13a, 13b, and 13c are provided at the back surface side of the upper and lower horizontal members 11c and 11d which form the frame 11 of the panel 10a that is in the forward direction.

Also, multiple positioning holes 14 are provided at the upper and lower horizontal members 11c and 11d which form the frame 11 of the panel 10b that is at the rear direction.

The interval between the multiple positioning holes 14 provided on the rear direction panel 10b is set to be half of the interval between the two insertion nuts 13b and 13c at the overlap portion side provided on the forward direction panel 10a.

The two forward direction panels 10a and 10b are fixed at a prescribed position to fix the length of the front panel 10 by overlapping a portion of the two forward direction panels 10a and 10b and by aligning the positioning hole 14 of the rear direction panel 10b with the position of the insertion nuts 13b and 13c of the forward direction panel 10a, and then inserting the bolts 15a and 15b from the rear of the panel 10b.

The rear direction panel 10b has positioning holes 14 which have an interval which is half of the interval between the insertion nuts 13b and 13c at the forward direction panel 10a, and thus fine adjustment of width is possible.

In addition, in the case overlap allowance is large, the fixing stability of the two panels can be improved by using the insertion nuts 13a located in the rear of forward direction panel 10a.

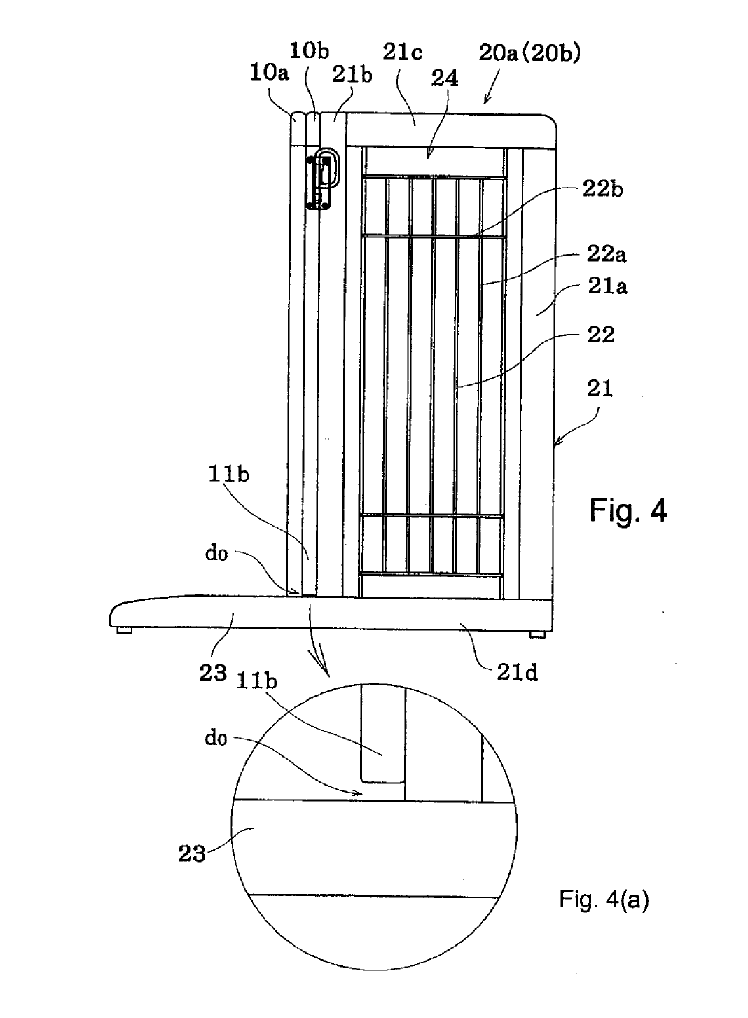

As shown in FIG. 1 and FIG. 2, the side panels 20a and 20b have the same structure, and thus, the explanation will be based on only one which is side panel 20a in FIG. 4.

The side panel 20a comprises the frame 21 and linear members 22. The frame 21 comprises left and right vertical members 21a and 21b (also referred to herein as vertical frame members) and upper and lower horizontal members 21c and 21d (also referred to herein as horizontal frame members). Vertical linear members 22a and horizontal linear members 22b are provided in the frame.

As is the case with the front panel 10, the middle ⅖ or more of the side panel 20a also has only the vertical direction member 22a. Again, there may be horizontal members 22b in addition to the horizontal frame members 21c and 21d of the side panel 20a. However, these horizontal members 22b are preferably only present in at most the vertical extreme 3/10 of the side panel 20a. The vertical direction member 22a is provided with a handle space 24 by drawing out the upper side of the frame 21, and thus, it is easy for the gate to be held with the hands when it is being moved.

The lower horizontal member 21d of the frame 21 has a support member 23 which extends in the opposite direction to the side panel 20a so as to intersect the front panel 10. This improves the stand-alone stability of the gate.

In this working example in particular, stand-alone stability is improved because the two side panels 20a and 20b are joined so as to be rotatable with respect to the front panel. When one of the side panels 20a and 20b rotates, the support member 23 is present at the other side of the side panels.

In the example shown in FIG. 4, the support member 23 is formed by extending the horizontal member of the frame 21, but a different product may be formed by joining the side panel 20a to the support member 23.

Next, the structure in which the front panel 10 and the side panels 20a and 20b are joined will be described.

As shown in FIG. 1 and FIG. 2, the lock device 30 is mounted to the outside corner of the planar view reverse C shape and to the inside corner of the reverse C shape. The front panel 10 and the side panels 20a and 20b are joined using the upper hinge 40 and the lower hinge 50.

Thus, when the lock device 30 is released, the connecting shaft of the upper hinge 40 and the lower hinge 50 is at the rotation center and rotates to the reverse C shape inner side but does not rotate from the lock state to the outer side.

When being used as a gate, only one of the side panels 20a and 20b is rotated so that a person can pass through, and when the gate is folded, both sides of the side panels 20a and 20b are rotated.

It is to be noted that as shown in the planar view of FIG. 3(a), the hinges 40 and 50 provided on the forward direction panel 10a are aligned with the rear direction panel 10b and at the position in the rotation cross direction. A spacer 17 that corresponds with the thickness of the rear direction panel 10b is mounted.

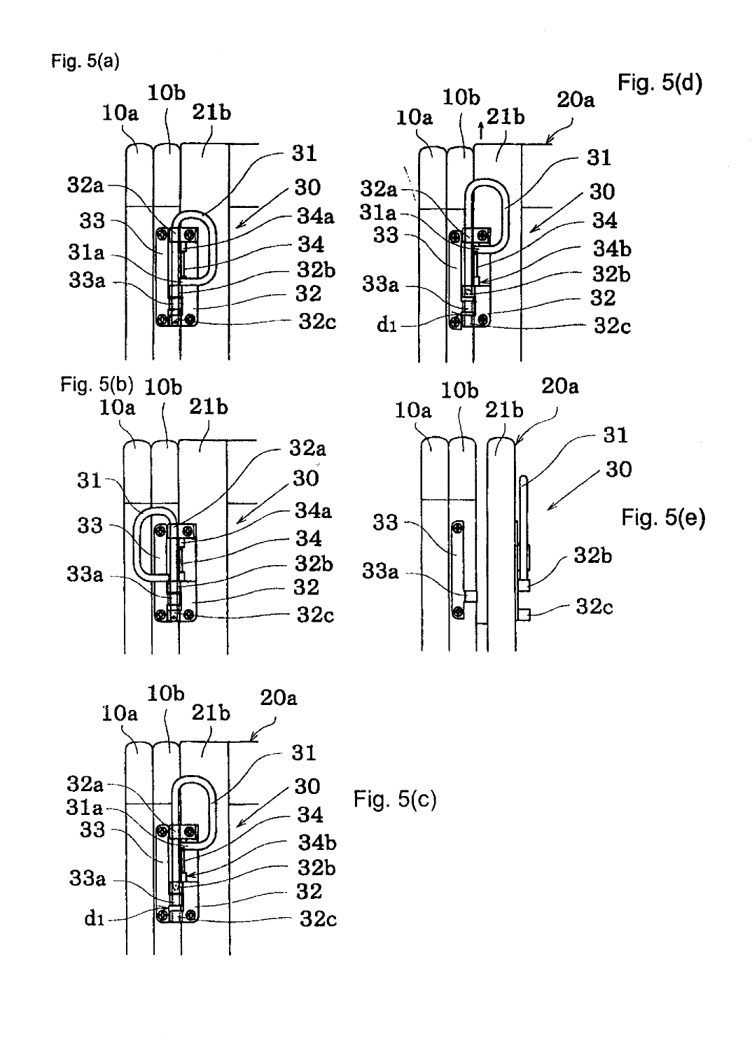

An example of the structure of the lock device will be described based on FIG. 5.

FIG. 5(a) shows the lock state in which the side panel 20a is rotated to the rear direction panel 10b.

A fitting 32 is fixed to the vertical member 21b of the side panel 20a, and a fitting 33 is fixed to the side and surface of the panel 10b of the front panel 10 side. Cylindrical portions 32a, 32b, 32c and 33a are formed at the fitting 32 and 33, and the lock pin 31 is mounted so as to communicate vertically with the cylindrical portions.

The fitting 32 has an anchor protrusion 34, and the upper and lower portions thereof have lock pin anchors 34a and 34b.

The pin of the lock pin 31 in the state in FIG. 5(a) is inserted into the cylindrical portion 33a of the fitting 33 of the front panel side, and the portion of anchoring 31a of the lock pin 31 is brought in contact with the anchor 34b. The side panel 20a is in the lock state in which rotation is controlled.

FIG. 5(b) shows the state in which the lock pin 31 is rotated to the left side in FIG. 5(b) so that the lock pin 31 can be raised.

The lock pin 31 is lifted in the state of FIG. 5(b), and as shown in FIG. 5(c), when the lock pin 31 is turned to the left, the tip of the lock pin 31 is disengaged from the cylindrical portion 33a of the fitting 33 of the front panel side.

The side panels are joined by the hinges 40 and 50 so as to be rotatable to the inside as shown in FIG. 2, and thus the side panel 20a is in a state where rotation is possible.

In this state, as shown in FIG. 5(d), the side panel 20a is lifted and slightly raised. It is to be noted that the raised structure is described hereinafter.

The state in which the reverse C shape inner side of the gate is rotated while slightly raising the side panel 20a is shown in FIG. 5(e).

In the case where the side panel 20a is returned to the direction of intersection with the front panel, the opposite operation is done.

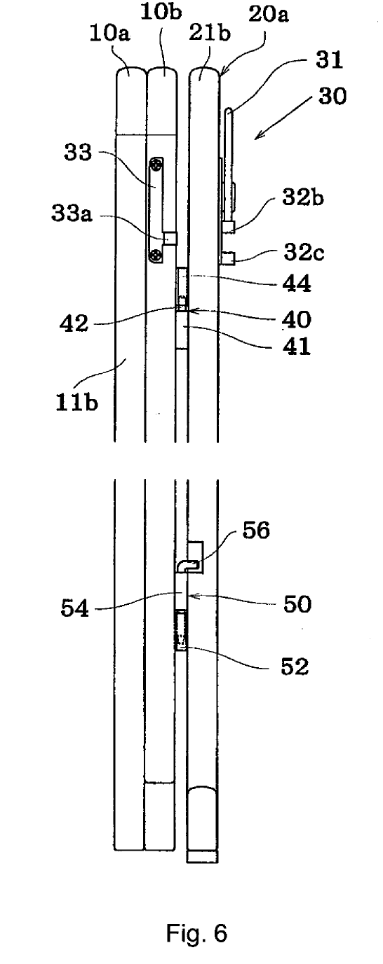

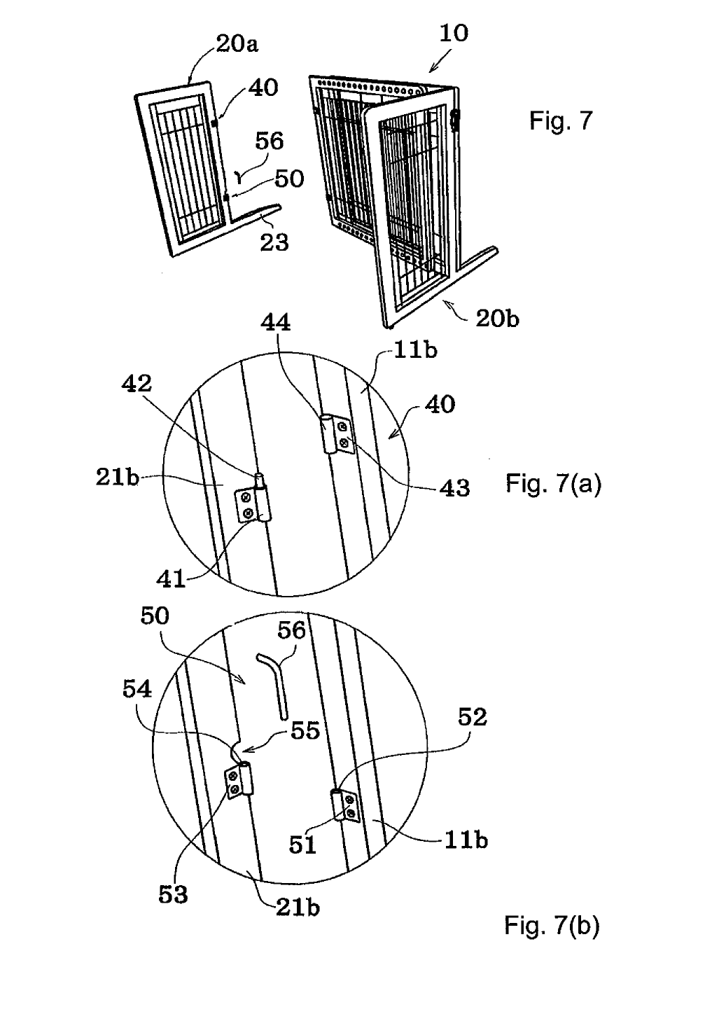

The inside of the side panels 20a and 20b are joined by the hinges 40 and 50 as shown in FIG. 2, FIG. 6, and FIG. 7, and thus, the side panels 20a and 20b rotate to the inside but do not rotate to the outside.

FIG. 6 is a view from the outside of side panel 20a when rotated to the inside. FIG. 7 is a view from the inside of the hinge portion of the side panel 20a, and thus in FIG. 6 and FIG. 7, the hinges appear in the opposite positions in terms of left and right.

The upper hinge 40 has a cylindrical portion 44, and the fitting 43 is fixed to the vertical member 11b of the front panel. The pin portion 42 of the fitting 41 mounted on the vertical member 21b of the side panel 20a is inserted into cylindrical portion 44 of the front panel side from below.

At the lower hinge 50, the fitting 53 at the side panel side is placed on the fitting 51 at the front panel side, and the pin fitting 56, which has been bent substantially in an L-shape, is inserted into the cylindrical portions 54 and 52 provided on the fittings 53 and 51 to join the front panel and side panel.

As a result, as shown in FIG. 7, when the pin fitting 56 is taken out, the front panel and the side panel can be separated.

As shown in FIG. 2 and FIG. 3, the upper hinge 40, the lower hinge 50, and the lock device that are inside are in a state in which the side panel is placed on the mounting surface and play allowance d1 in the vertical direction is provided. The side panel can move vertically only by the amount of the play allowance d1.

On the other hand, as shown in the exploded views of the lower portions in FIG. 3 and FIG. 4, at least the lower end of the vertical member 11b, which forms the front panel, extends above the support member 23, and the raise allowance d0 is set.

For example, if d1 is set so as to be between 4 and 6 mm, and d0 is set to between 2 and 4 mm, the side panels can be raised up from the mounted surface in the range of this raise allowance d0, and the rotating operation can be performed.

As a result, when the side panel is rotated, frictional resistance on the mounting surfaces is reduced or eliminated, and the rotating operation becomes easy.

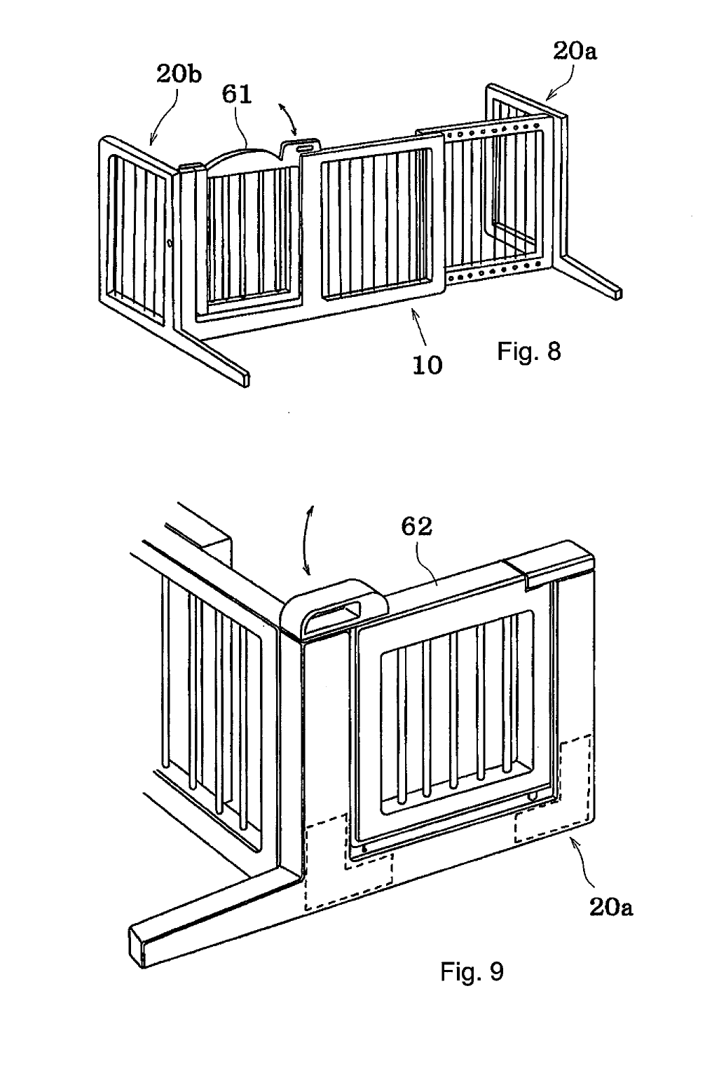

An example using the pet gate of the disclosure is shown in FIG. 8 to FIG. 12.

FIG. 8 is an example in which the door 61, which can open and close when a person passes through, is provided in the front panel 10, and FIG. 9 is an example in which the open and close door 62 is provided in the side panel 20a.

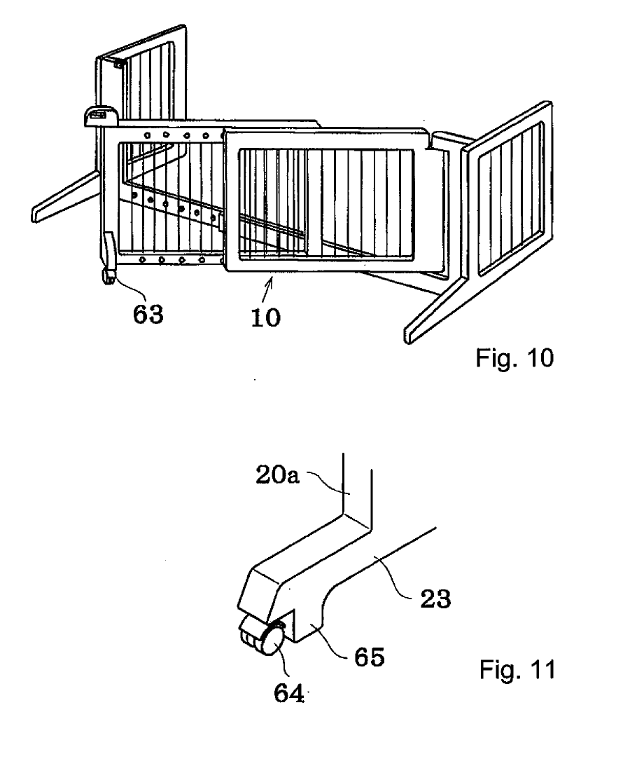

In addition, FIG. 10 shows the case where the entire front panel 10 opens and closes using a caster 63.

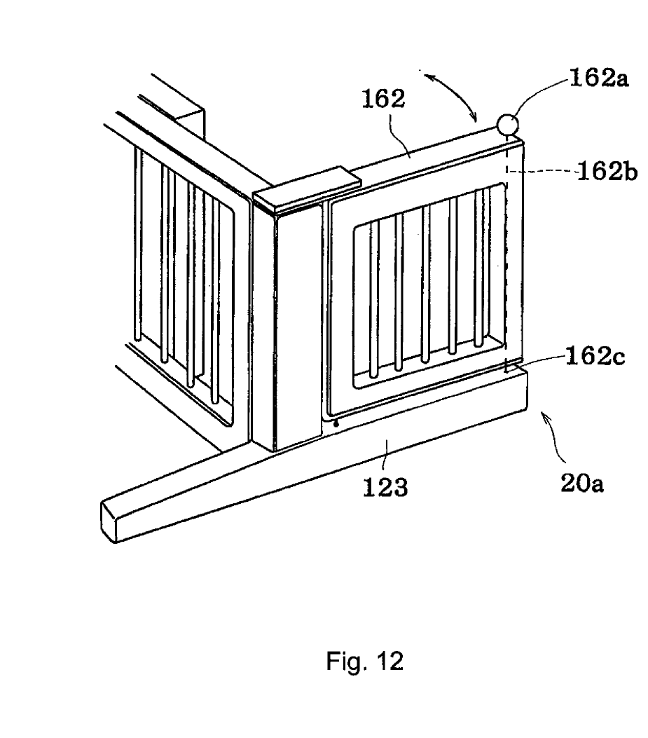

FIG. 11 is an example in which a leg 65 and a caster 64 are provided in the vicinity of the tip of the support member 23 of the side panel 20a, and the side panel 20a is moved by being inclined with the caster 64 as the support point. When placed on the floor surface, movement is controlled by the leg 65.

It is to be noted that in the case of the working example shown in FIG. 11, the side panels do not necessarily have to rotate with respect to the front panel, and the structure may be such that the entire gate moves.

FIG. 12 is an example in which a separate support member 123 is provided on the front panel, and the support shaft of the open and close door 162 is provided on the front panel.

The open and close door 162 is opened and closed when its lower end fits into the hole 162c that goes through the open and close door 162 and the support member 123. The rod 162b, which locks the open and close door 162, is removed from the hole 162c by lifting up the knob 162a and thereby releasing the lock.

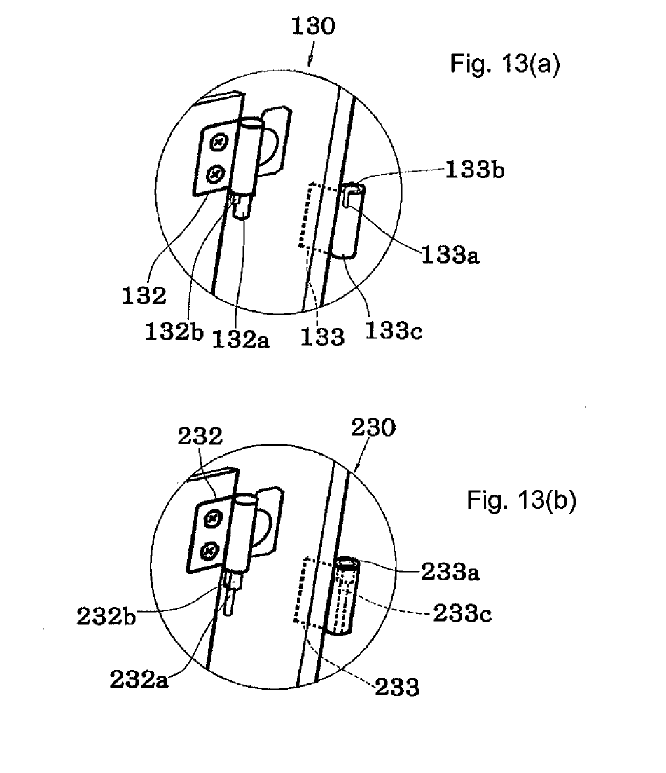

FIG. 13 shows an example in which the hinge has a lock function.

The hinge 130 with the lock function that is shown in FIG. 13(a) has a cylindrical portion 133c at the fitting of the front panel side as well as a notched groove 133a. The hinge portion 132a and the lock anchor 132b are formed on the fitting 132 of the side panel side.

When fit into the notched groove 133a, rotation of the lock anchor 132b is locked. When the side panel is lifted a little, and the lower end of the lock anchor 132b is removed from the upper end of the notched groove 133a, the lower end of the lock anchor 132b rotates so as to slide in the slide portion 133b.

The example of the hinge with the lock function that is shown in FIG. 13(b) has a square hole 233a at the fitting 233 fixed at the front panel side, and a round hole 233c is formed under the square hole 233a. The fitting 232, which is fixed at the side panel side, has a square pin portion 232b, which has the same shape as the inner shape as the square hole 233a. A round pin 232a is under the square pin portion 232b.

As a result of this configuration, rotation is locked when the square pin portion 232b fits into the square hole 233a, and the side panel is lifted up slightly. When the lower end of the square pin portion 232b is removed from the upper end of the square hole 233a, rotation is permitted with the round pin 232a as the axis.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A freestanding pet gate comprising:
a front panel;
a side panel disposed at each side of the front panel, wherein each side panel extends in a direction of intersection with the front panel allowing the pet gate to stand alone; and
a door formed by one of the side panels in its entirety;
wherein the door is coupled on one side to the front panel by a hinge that allows rotation, and another side of the door is free;
wherein the door swings about the hinge in such a way that when in a state of use, the door opens and closes to allow passage of persons; and
wherein the gate is set to a height such that it is difficult for a person to step over the gate.

2. The pet gate of claim 1, wherein the side panels are rotatively joined to the front panel and form the door that opens and closes when people pass through.

3. The pet gate of claim 1, wherein the front panel comprises multiple panels overlapping in a horizontal direction.

4. The pet gate of claim 2, wherein rotating the side panels with respect to the front panel slightly raises the side panels from a mounting surface.

5. The pet gate of claim 1, wherein the front panel is extensible in a width direction.

6. The pet gate of claim 2, wherein the front panel is extensible in a width direction.

7. The pet gate of claim 1, wherein the front panel and the side panels are collapsibly joined.

8. The pet gate of claim 2, wherein the front panel and the side panels are collapsibly joined.

9. The pet gate of claim 1, wherein the front and the side panels comprise a frame portion and linear members disposed inside the frame portion;
wherein the front and the side panels further comprise at least one horizontal member in addition to a horizontal frame member located within 3/10 or less of the vertical extreme portion of the panels; and
wherein ⅖ or more of the center portion of the front and side panels with respect to a vertical direction include linear members extending in a vertical direction only.

10. The pet gate of claim 2, wherein the front and the side panels comprise a frame portion and linear members disposed inside the frame portion;
wherein the front and the side panels further comprise at least one horizontal member in addition to a horizontal frame member located within 3/10 or less of the vertical extreme portion of the panels; and
wherein ⅖ or more of the center portion of the front and side panels with respect to a vertical direction include linear members extending in a vertical direction only.

11. The pet gate of claim 3, wherein the front and the side panels comprise a frame portion and linear members disposed inside the frame portion;
wherein the front and the side panels further comprise at least one horizontal member in addition to a horizontal frame member located within 3/10 or less of the vertical extreme portion of the panels; and
wherein ⅖ or more of the center portion of the front and side panels with respect to a vertical direction include linear members extending in a vertical direction only.

12. The pet gate of claim 9, wherein the at least one horizontal member is within the top 3/10 or less of at least one of the panels.

13. The pet gate of claim 9, wherein the at least one horizontal member is within the bottom 3/10 or less of at least one of the panels.

14. The pet gate of claim 9, wherein the at least one horizontal member comprises at least two horizontal members wherein at least one of the horizontal members is within the top 3/10 or less of at least one of the panels and at least one of the horizontal members is within the bottom 3/10 or less of at least one of the panels.

15. The pet gate of claim 1, wherein the pet gate has a height in the range between 55 cm and 100 cm.

16. The pet gate of claim 1, wherein the pet gate has a height in the range between 65 cm and 80 cm.

17. The pet gate of claim 4, wherein the side panels are raised between 2 mm and 4 mm.

18. The pet gate of claim 4, wherein the side panels are raised by a hinge, comprising:
a first fitting, which is fixed at the front panel side, having a top inner shaper and a bottom inner shape formed under the top inner shape; and
a second fitting, which is fixed at the side panel side, having a top pin portion with the same shape as the top inner shape of the first fitting and a bottom pin portion under the top pin portion with the same shape as the bottom inner shaper of the first fitting;
such that the side panels are raised when the top pin portion fits into the top inner shape.

19. The pet gate of claim 18, wherein rotation of the side panels are locked when the top pin portion fits into the top inner shape, and rotation is permitted when a lower end of the top pin portion is removed from an upper end of the top inner shape.

20. The pet gate of claim 4, wherein the side panels are placed on a mounting surface and a play allowance in the vertical direction is provided, such that the side panel can move vertically only by the amount of the play allowance; and
wherein at least a lower end of a vertical member, which forms the front panel, extends above a support member to set a raise allowance, such that if the play allowance is set between 4 and 6 mm, and the raise allowance is set to between 2 and 4 mm, the side panel can be raised up from the mounting surface in the range of the raise allowance, and the rotating operation can be performed.
